(19) United States
(12) Patent Application Publication
(10) Pub. No.: US 2013/0296151 A1
(43) Pub. Date: Nov. 7, 2013

(54) COUNTER EJECTOR AND BOX FORMER

(71) Applicants: Osamu Hatano, Mihara-shi (JP); Toshiaki Miyakura, Mihara-shi (JP); Shinya Iori, Mihara-shi (JP)

(72) Inventors: Osamu Hatano, Mihara-shi (JP); Toshiaki Miyakura, Mihara-shi (JP); Shinya Iori, Mihara-shi (JP)

(73) Assignee: MITSUBISHI HEAVY INDUSTRIES PRINTING & PACKAGING MACHINERY, LTD, Mihara-shi, Hiroshima (JP)

(21) Appl. No.: 13/882,115

(22) PCT Filed: Jan. 26, 2012
(86) PCT No.: PCT/JP2012/051633

§ 371 Date: Jul. 1, 2013

(30) Foreign Application Priority Data
Jan. 31, 2011 (JP) 2011-017589

(51) Int. Cl. B31B 1/02

(52) U.S. Cl. CPC B31B 1/02
USPC 493/53; 414/789.9

(57) ABSTRACT

A counter ejector is configured to receive a sheet-shaped corrugated board box forwarded from an upstream side by the hopper and to eject the sheet-shaped corrugated board box in units of batch. The counter ejector includes a front stop defining a hopper for stopping the sheet-shaped corrugated board box forwarded from the upstream side; an elevator including a mount that receives the sheet-shaped corrugated board box falling after hitting the front stop; a ledge activated when the number of sheet-shaped corrugated board box forming a stack piled on the mount reaches a predetermined number for receiving a sheet-shaped corrugated board box that is to form a next stack; a support ledge disposed under a front of the hopper for receiving the stack formed on the ledge; and a position setting mechanism that variably sets a vertical position of the support ledge.

### RELATED APPLICATIONS

The present application is a National Phase of International Application Number PCT/JP2012/051633, filed Jan. 26, 2012, and claims priority from Japanese Application Number 2011-017589, filed Jan. 31, 2011.

### FIELD

The present invention relates to a counter ejector that is disposed at the most downstream part of a box former and that counts corrugated board boxes and ejects the corrugated board boxes in batches, and a box former using the counter ejector thereof.

### BACKGROUND

A box former that manufactures corrugated board boxes includes a counter ejector that counts manufactured corrugated board boxes at the most downstream part of the box former and ejects the corrugated board boxes piled in batches each containing a predetermined number of sheets.

Recently, the speed of manufacturing in the box former has been increased, which has arisen a demand for increasing the processing speed of the counter ejector. In view of the above, there have been proposed various techniques related to the counter ejector.

For example, Patent Literature 1 discloses a counter ejector having the configuration illustrated in FIGS. 11(a)-11(b). As illustrated in FIG. 11(a), the exit (the most downstream section) of a folder gluer 101 and a pair of vertically arranged forwarding rolls 102 are attached to upper stream of the counter ejector of Patent Literature 1. A spanker 111 that depresses the edge of a stack 150 is disposed at a lower portion of the forwarding rolls 102, and a front stop 126 that stops a sheet-shaped corrugated board box 103 ejected from the folder gluer 101 and that is movable in forward and backward directions is disposed ahead (downstream) of the forwarding rolls 102.

The space between the spanker 111 and the front stop 126 is a hopper section H in which the sheet-shaped corrugated board boxes 103 are piled as the stack 150.

A support ledge 122a is attached to the bottom of the spanker 111 so as to go into and out of the hopper H. Furthermore, a pusher 124 that pushes the stack 150 is disposed under the support ledge 122a so as to go in and out. Another support ledge 122b is disposed at the bottom of the front stop 126 so as to go into and out of the hopper H. The support ledges 122a and 122b face each other and cooperatively receive the stack 150 on a ledge 136 to be detailed below.

An elevator 129 is disposed below the front stop 126, so that the corrugated board boxes 103 which hit the front stop 126 and fall are received and piled as the stack 150 on the elevator 129. The elevator 129 is substantially horizontally arranged slightly ahead (downstream) of the forwarding rolls 102 and is configured to be vertically movable. A blower 132 that blows air AF on the top surface of the corrugated board box 103 is disposed over the elevator 129. The position of the blower 132 is higher than that of the corrugated board box 103 forwarded from the forwarding rolls 102.

The ledge 136 is disposed opposite to and ahead (downstream) of the forwarding rolls 102. The ledge 136 is configured to be vertically movable and to go into and out of the hopper H. As illustrated in FIG. 11(b), the ledge 136 is activated, when the corrugated board boxes 103 received on the elevator 129 and piled as the stack 150 on the elevator 129 reached a predetermined number, so as to receive the corrugated board boxes 103a that are to be piled as a next stack 150a. A vertical direction member 136a of the ledge 136 supports a press bar 138, which depresses the stack 150 and is vertically movable by an air cylinder 139.

An ejecting conveyor 140 is disposed at the same level as the top surface of the elevator 129 at its possible lowest position and at a position sufficiently close to the pusher 124 to handle the minimum box size. When the ledge 136 comes to receive the corrugated board boxes 103a that are to form the next stack 150a, the elevator 129 immediately starts moving down to the same level as the ejecting conveyor 140. At this time, in order to avoid collapse of the stack 150 due to spring back, the press bar 138 is depressed down from the ledge 136 and thereby the stack 150 is brought down, being sandwiched between the press bar 138 and the elevator 129. When the top surface of the stack 150 passes the support ledges 122a and 122b, the support ledges 122a and 122b project inside the hopper H and come into the stand-by state. Concurrently, the next stack 150a is formed on the ledge 136.

An exit conveyer 141 is disposed downstream of the ejecting conveyor 140 and an upper conveyer 144 is disposed over the exit conveyer 141. The position of the upper conveyer 144 can be adjusted both in the machine direction (i.e., the lateral direction of FIGS. 11(a)-11(c)) and the height direction. The upper conveyer 144 moves together with the front stop 126 by a predetermined distance from the front stop 126 in accordance with the size of a corrugated board box. As illustrated in FIG. 11(c), after the pusher 124 extrudes the stack 150 on the ejecting conveyor 140 in order for the stack 150 to be sandwiched between the ejecting conveyor 140 and the upper conveyer 144, the upper conveyer 144 brings out the stack 150 in a batch, sandwiching the stack 150 from the top and the bottom in cooperation with the ejecting conveyor 140 and the exit conveyer 141.

When the batch starts moving by the ejecting conveyor 140 as shown by the arrow of FIG. 11(c), the press bar 138 slightly rises to leave the top surface of the batch and the ledge 136 evacuates in conjunction with the press bar 138 to such a position that the ledge 136 does not interfere with the stack 150a, waiting for the next rise. At this time, the stack 150a on the ledge 136 is supported by the support ledges 122a and 122b. During the above process, the batch completely leaves the elevator 129.

After that, when the elevator 129 rises to the same level as that of the support ledges 122a and 122b, the support ledges 122a and 122b withdraw and the stack 150a, which has been on the support ledges 122a and 122b, is received by the elevator 129. During this movement, the press bar 138 is accommodated in the ledge 136, and the ledge 136 and the press bar 138 together rise and move forward to return to the state of FIG. 11(a). This procedural cycle is repeated until a required number of batches are ejected.

According to the above counter ejector, partly since the ejecting conveyor 140 is disposed sufficiently close to the pusher 124, thereby allowing to handle boxes having a possible minimum size and partly since the upper conveyer 144 can adjust its position in synchronization with the front stop 126, the stroke of the pusher 124 can be shortened, so that a required operation time can be reduced. Since the support ledges 122a and 122b, instead of the ledge 136, temporarily support the stack 150 and the ledge 136 can start the evacuation immediately after the press bar 138 finishes the function of depressing the stack 150, a required operation time can be reduced. In addition, since air pressure from the blower 132 depresses the top surface of the stack 150, such reduction in required operation time can largely reduce the cycle time.

### PRIOR ART REFERENCE

### Patent Literature

### [Patent Literature 1] Japanese Laid-Open Publication No. 2008-149730

### SUMMARY OF INVENTION

### Problems to be Solved by Invention

The technique of above Patent Literature 1 can enhance the operation speed of the box former. The support ledges 122a and 122b, which hold the sheet-shaped corrugated board boxes 103 until the batch formed in the hopper H includes a predetermined number of sheets, horizontally move but the vertical positions thereof cannot be adjusted so that the following problems occur.

When the thickness of each individual corrugated board box 103 is small or when the number of sheets included in a batch is small, the fall distance from the point where the corrugated board box 103 enters the hopper H to the top surface of the pile is large so that the corrugated board boxes 103 are unstably piled and a properly-shaped batch is not formed.

In particular, since a demand for thin corrugated board boxes has arisen in recent years, setting the heights of the support ledges to deal with also a thick corrugate board box makes the fall distance to the top surface of the pile large. In a case where a batch including a small number of sheets is demanded, the fall distance to the top surface of the pile becomes large and the resultant pile becomes unstable.

In addition to the above, demands for enhancing the operation speed of the machine further would unstably pile corrugated board boxes for a large fall distance and a high speed of corrugated board boxes when entering the hopper.

With the foregoing problems in view, the object of the present invention is to provide a counter ejector that prevents the fall distance from the point where the sheet-shaped corrugated board box enters the hopper to the top surface of the pile from being excessively large to stably pile the sheet-shaped corrugated board boxes and the box former including the counter ejector.

### Means to Solve the Problems

To attain the above object, the counter ejector of the present invention is disposed at a downstream part of a box former, includes hopper, receives a sheet-shaped corrugated board box forwarded from an upstream side by the hopper and ejects the sheet-shaped corrugated board box in units of batch. The counter ejector includes front stop that defines the hopper and stops the sheet-shaped corrugated board box forwarded from the upstream side; an elevator that includes a mount that receives the sheet-shaped corrugated board box falling after hitting the front stop; a ledge that is activated when the number of sheet-shaped corrugated board box forming a stack piled on the mount reaches a predetermined number and that receives a sheet-shaped corrugated board box that is to form a next stack; a support ledge that is disposed under the front of the hopper and that receives the stack formed on the ledge; and a position setting mechanism that variably sets a vertical position of the support ledge.

The position setting mechanism preferably includes a lift actuator that raises and lowers the support ledge.

The counter ejector preferably further includes control means that sets the optimum vertical position of the support ledge in accordance with the thickness of the sheet-shaped corrugated board box or the number of sheets included in the batch and that controls the lift actuator such that the support ledge comes to be the optimum vertical position.

The position setting mechanism preferably includes a plurality of the support ledges disposed at vertically different positions and sets the vertical position of the support ledge by selectively using one from the plurality of support ledges.

The counter ejector preferably further includes control means that sets the optimum vertical position of the support ledge in accordance with the thickness of the sheet-shaped corrugated board box or the number of sheets included in a batch and that selectively activates one of the plurality of the support ledges that is at the closest to the optimum vertical position.

The counter ejector preferably further includes a plurality of the support ledges disposed at the same height; and a horizontal actuator that horizontally moves the plurality of support ledges such that the plurality of support ledges enter the hopper when the plurality of support ledges are activated to receive the stack on the ledge and evacuate from the hopper when the plurality of support ledges are not activated.

In particular, the plurality of the support ledges are preferably disposed under the front stop and under a forwarding roll disposed at a downstream part of the box former.

The elevator preferably includes an elevator driving device that raises and lowers the mount; and the elevator driving device preferably include a plurality of lift mechanisms that are arranged in series and that are capable of simultaneously raising and lowering the mount.

The counter ejector preferably includes control means that causes the plurality of lift mechanisms to simultaneously raise and lower the mount when the mount of the elevator is raised and lowered.

The mount preferably includes a plurality of mount segments that are arranged in the transfer direction of the sheet-shaped corrugated board box and are configured to ascend and descend independently of one another.

The counter ejector preferably further includes a blower that blows air from a higher point of the sheet-shaped corrugated board box to the hopper, wherein the blower varies a blowing area at least along the transfer direction of the sheet-shaped corrugated board box, and if the sheet-shaped corrugated board box has a possible maximum length in the transfer direction, the blower has the blowing area corresponding to at least the rear-end portion and the front-end portion of the hopper along the transfer direction.

The box former of the present invention includes a feed section that feeds a corrugated board sheet one at a time; a print section that prints an image or a letter on the corrugated board sheet fed from the feed section; a slotter creaser section that ejects the corrugated board sheet printed in the print section; a die cutting section that die-cuts the corrugated board sheet ejected from the slotter creaser section; a folder gluer section that glues and folds the edge of the corrugated board sheet processed by the die cutting section to thereby form a sheet-shaped corrugated board box; and a counter ejector section that counts and piles the corrugated board box processed by the folder gluer section, wherein the counter ejector includes: a front stop that defines a hopper and stops the sheet-shaped corrugated board box forwarded from an upstream side; an elevator that includes a mount that receives the sheet-shaped corrugated board box falling after hitting the front stop; a ledge that is activated when the number of sheet-shaped corrugated board box forming a stack piled on the mount reaches a predetermined number and that receives a sheet-shaped corrugated board box that is to form a next stack; a support ledge that is disposed under the front of the hopper and that receives the stack formed on the ledge; and a position setting mechanism that variably sets a vertical position of the support ledge.

### Effects of Invention

Since the counter ejector and the box former of the present invention include the position setting mechanism that variably sets a vertical position of the support ledge receiving the stack on the ledge, the vertical position of the support ledge can be properly set, for example, in accordance with an assumed position of the top surface of the stack on the support ledge, depending on the thickness of a sheet-shaped corrugated board box or the number of sheets included in the batch, so that the fall distance from the point where the corrugated board box enters the hopper to the top surface of the pile can be suppressed. Thereby, the sheet-shaped corrugated board boxes can be stably piled.

The elevator driving device being configured to include a plurality of lift mechanisms that are arranged in series and that are capable of simultaneously raising and lowering the mount makes it possible to rapidly move the mount of the elevator through causing the plurality of the lift mechanisms to simultaneously raise and lower the mount. When the support ledge is raised in order to suppress the fall distance when the corrugated board box enters the hopper, the rise-and-lower stroke of the mount of the elevator needs to be increased, which leads to increase in cycle time of raising and lowering the elevator. In this event, although there is possibility that the cycle time of the elevator cannot keep up with the operational cycle time of the counter ejector, simultaneous activation of multiple lift mechanisms enhances the speed of raising and lowering the elevator. The cycle time of raising and lowering the elevator can be suppressed to keep up with the operational cycle time of the counter ejector.

As described above, the counter ejector always guarantees stable piling of corrugated board boxes regardless of the sheet thickness of the corrugated board boxes and the number of sheets included in a single batch. The box former of the present invention, which includes the above counter ejector, achieves properly manufacturing the corrugated board boxes in response to various orders related to the sheet thickness of the corrugated board boxes and the number of sheets included in a single batch, so that the versatility of the box former can be greatly improved.

### BRIEF DESCRIPTION OF DRAWINGS

FIG. 1 is a schematic side view illustrating the main part structure of a counter ejector according to a first embodiment;

FIGS. 2(a)-2(d) are side views illustrating the operations of the main part of the counter ejector of the first embodiment: FIGS. 2(a), 2(c), and 2(d) are schematic side views of the main part illustrating variations of operations; and FIG. 2(b) is an enlarged view of the main part of FIG. 2(a) (arrow view in direction A).

FIG. 3 is a side view depicting the entire structure of a counter ejector of the first embodiment (omitting frames disposed frontward of the drawing and illustrating the inside of the counter ejector);

FIGS. 4(a), 4(b), and 4(c) are schematic side views illustrating the movement in sequence of FIGS. 4(a), 4(b), and 4(c) of a counter ejector of the first embodiment;

FIGS. 5(a), 5(b), and 5(c) are schematic side views illustrating the movement in sequence of FIGS. 5(a), 5(b), and 5(c) of a counter ejector of the first embodiment;

FIGS. 6(a) and 6(b) are schematic side views illustrating the movement in sequence of FIGS. 6(a) and 6(b) of a counter ejector of the first embodiment;

FIG. 7 is a side view of a box former including a counter ejector according to each embodiment of the present invention;

FIG. 8 is a schematic side view of the main part structure of a counter ejector according to a second embodiment;

FIG. 9 is a schematic side view of the main part structure of a counter ejector according to a third embodiment;

FIG. 10 is a schematic side view of the main part structure of a counter ejector according to a fourth embodiment;

FIGS. 11(a), 11(b), and 11(c) are schematic side views illustrating the movement in sequence of FIGS. 11(a), 11(b), and 11(c) of a counter ejector related to a background technique.

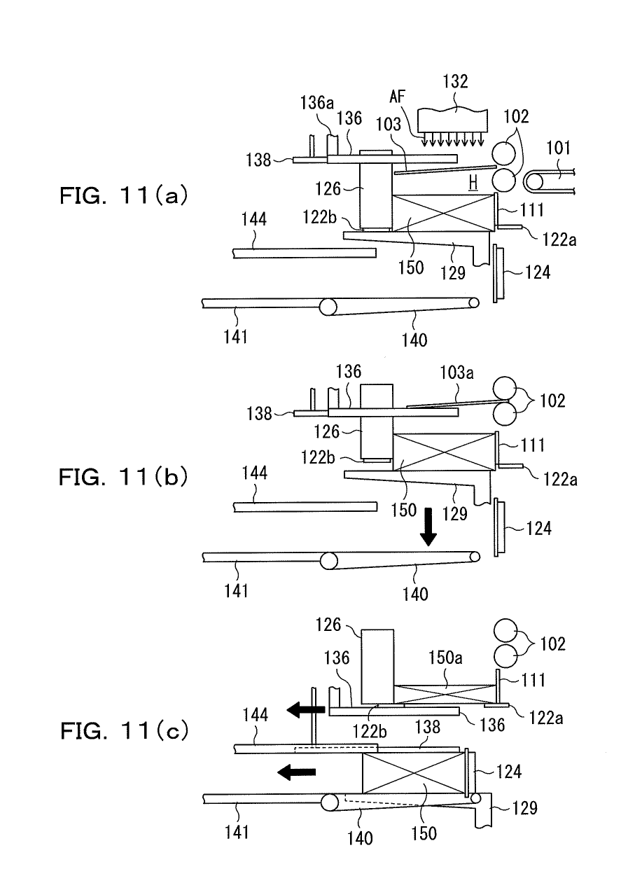

### EMBODIMENTS TO CARRY OUT INVENTION

Hereinafter, embodiments of the present invention will now be described with reference to the accompanying drawings.

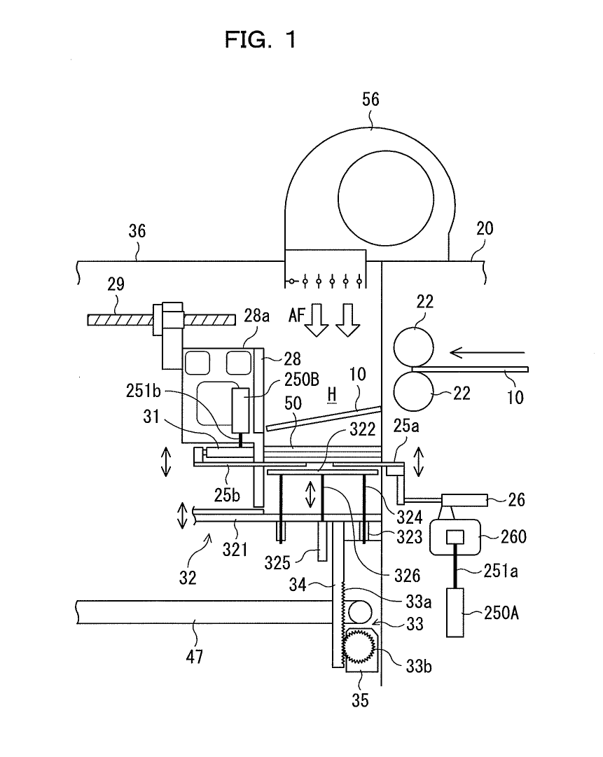

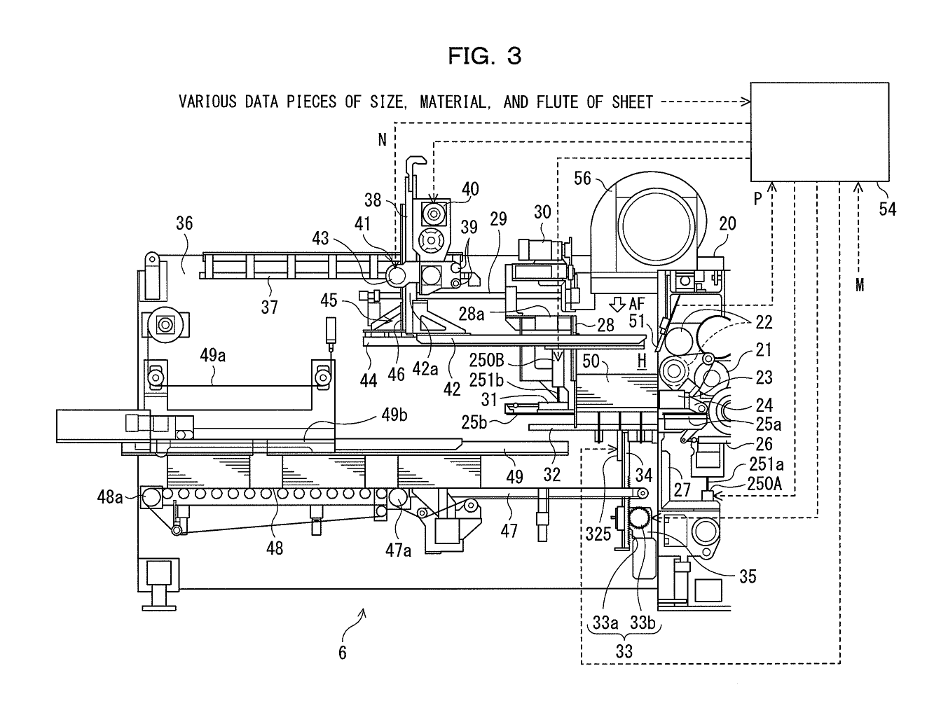

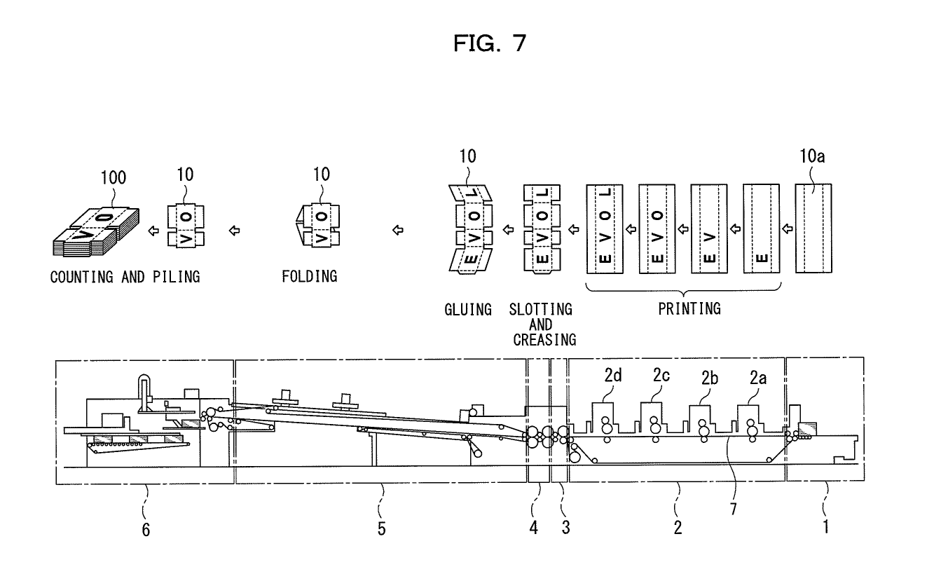

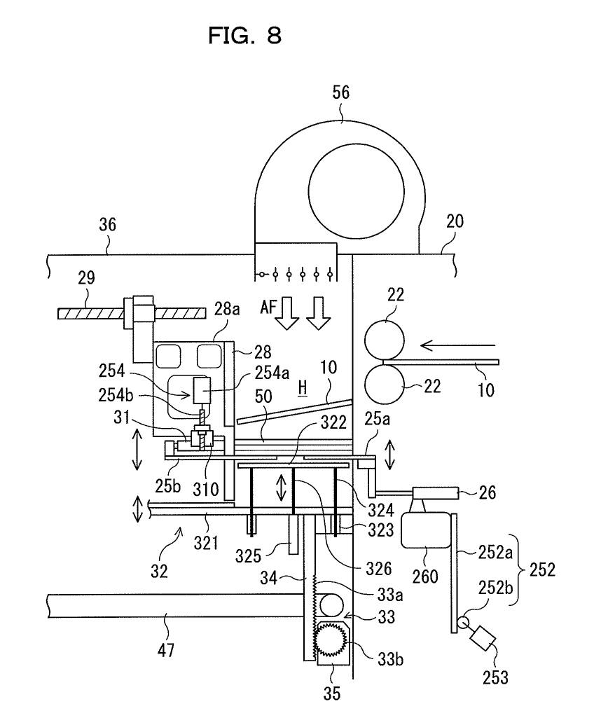

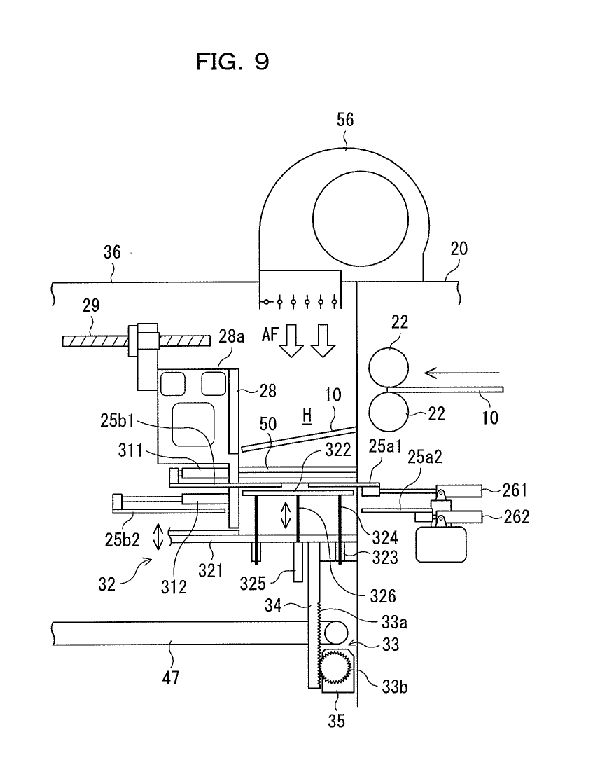

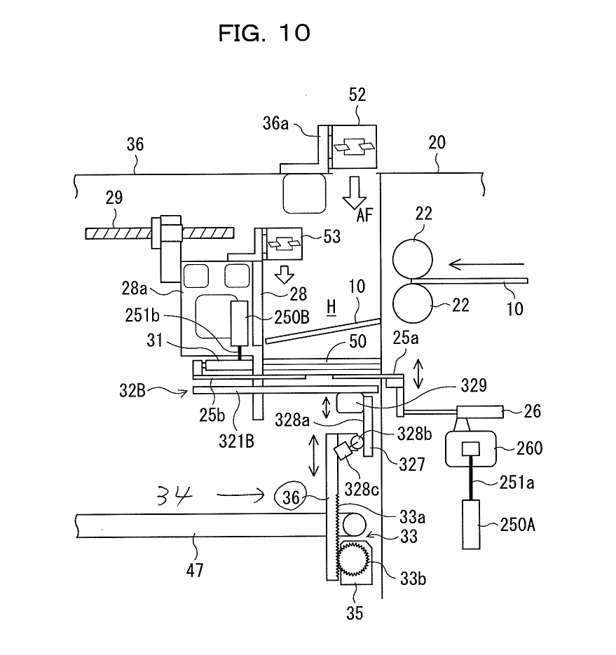

FIGS. 1-7 illustrate a counter ejector according to a first embodiment of the present invention; FIG. 8 illustrates a counter ejector according to a second embodiment; FIG. 9 illustrates a counter ejector according to a third embodiment; and FIG. 10 illustrates a counter ejector according to a fourth embodiment. FIGS. 3 and 7 are also used for referring to the second to the fourth embodiment in addition to the first embodiment.

### First Embodiment

To begin with, description will now be made in relation to the configuration of a box former including a counter ejector according to the first embodiment.

FIG. 7 is a side view of the configuration of a box former, associating with the procedural steps of processing a corrugated board sheet into a sheet-shaped corrugated board box (sheet to be formed into a box) on the upper part separately from the machine configuration of the box former below. As illustrated in FIG. 7, the box former includes from the upstream side, a feed section 1, a print section 2, a slater creaser section 3, a die cutting section 4, a folder gluer section 5, and a counter ejector 6.

A pile of multiple sheet-shaped corrugated board sheets 10a is conveyed into the feed section 1, which feeds (supplies) each individual corrugated board sheet 10a to the print section 2. The print section 2 includes a predetermined number (here, four) of printing units 2a-2d for the respective colors and sequentially prints the respective color inks on a corrugated board sheets 10a being conveyed individually by a transfer conveyer 7.

The slater creaser section 3 ejects the corrugated board sheets 10a underwent printing by the print section 2, and the next die cutting section 4 die-cuts the corrugated board sheets 10a. In succession, the folder gluer section 5 applies glue to tabs on the left or right of the corrugated board sheets 10a underwent the slotting and creasing and then folds the corrugated board sheets 10a such that the left ends and the right ends of the corrugated board sheets 10a overlap on the backsides (at the bottom). Namely, the folder gluer section 5 binds the left and right ends of the corrugated board sheets 10a with glue into sheet-shaped corrugated board boxes 10 (sheets to be formed into boxes).

The counter ejector section 6 counts sheet-shaped corrugated board boxes 10 processed in the folder gluer section 5 and piles the boxes 10 onto a table (stacker table). When a predetermined number of sheet-shaped corrugated board boxes 10 are piled, the sheet group 100 is regarded as a batch unit and is shipped.

Next, the counter ejector section 6 (i.e., the counter ejector of the embodiments) will now be described with reference to FIG. 3.

As illustrated in FIG. 3, frames 20 are vertically arranged on the both ends on the width direction at the entrance of the counter ejector 6. A conveyer roller 21 disposed at the exit (the rearmost position) of the folder gluer section 5 and a pair of forwarding rolls 22 vertically arranged are mounted on the frames 20. A spanker 23 that depresses the edge of a stack (a pile of multiple sheet-shaped corrugated board boxes 10) 50 that is to be detailed below is disposed at a lower portion of the forwarding rolls 22. The spanker 23 is coupled to a rotating lever 24 and is configured to move forward and backward by rotation of the rotating lever 24.

The space below the exit of the forwarding rolls 22 serves as a space (hopper) H where the sheet-shaped corrugated board boxes 10 are piled as the stack 50.

A support ledge 25a is attached to the bottom of the spanker 23 and is allowed to go into and out of the hopper H by an air cylinder 26. Furthermore, a pusher 27 that extrudes the stack 50 is disposed under the support ledge 25a and is allowed to go into and out of the hopper H by a non-illustrated actuator such as an air cylinder.

A front stop 28 that stops sheet-shaped corrugated board boxes 10 ejected from the folder gluer 5 is disposed ahead of the forwarding rolls 22 so as to face the forwarding rolls 22. The front stop 28 is supported to be movable in forward and backward directions. In detail, the upper portion of the front stop 28 is attached to a screw axis 29 that extends in the machine direction. Rotation of the screw axis 29 in response to the rotation of the motor 30 moves the front stop 28 forward and backward. Another support ledge 25b is disposed at the bottom of the front stop 28 so as to go into and out of the hopper H by an air cylinder 31. The support ledges 25a and 25b face each other and cooperatively receive the stack 50 on a ledge 42 to be detailed below.

The support ledges 25a and 25b are raised and lowered by a lift actuator 250A and a lift actuator 250B both serving as position setting mechanisms, respectively, so that the vertical positions of the support ledges 25a and 25b can be varied.

Specifically, as illustrated in FIG. 1, the support ledge 25a is engaged with a piston rod of the air cylinder 26 horizontally arranged and is therefore allowed to move into and out of the hopper H in accordance with horizontal movement of the piston rod in response to stretching and shrinking of the air cylinder 26. The supporter 260, which supports the support ledge 25a and the air cylinder 26, is engaged with and supported by the piston rod 251a of the air cylinder 250A serving as a lift actuator. The air cylinder 250A is vertically arranged, so that the vertical movement of the piston rod 251a responsive to stretching and shrinking of the air cylinder 250A vertically moves the supporter 260. The support ledge 25a sets the vertical position thereof in conjunction with the supporter 260 by stretching and shrinking the air cylinder 250A.

Similarly, the support ledge 25b is engaged with a piston rod of the air cylinder 31 horizontally arranged and is therefore allowed to move into and out of the hopper H in accordance with horizontal movement of the piston rod in response to stretching and shrinking of the air cylinder 31. A supporter (not illustrated), which supports the support ledge 25b and the air cylinder 31, is engaged with and supported by the piston rod 251b of the air cylinder 250B serving as a lift actuator. The air cylinder 250B is vertically arranged, so that the vertical movement of the piston rod 251b in response to stretching and shrinking of the air cylinder 250B vertically moves the supporter of the cylinder 31. The support ledge 25b sets the vertical position thereof in conjunction with the supporter by stretching and shrinking the air cylinder 250B.

The vertical positions of the support ledges 25a and 25b are set by a controller (controlling means) 54. Specifically, the controller 54 sets the support ledges 25a and 25b by activating the lift actuators (air cylinders) 250A and 250B in accordance with the thickness of each sheet-shaped corrugated board box 10 and the number of sheets of the batch 50 such that the fall distance from a position at which a sheet-shaped corrugated board box enters the hopper to the top surface of stack piled in the hopper is not excessively large.

The setting is assumed to be changed in accordance with the thickness of each sheet-shaped corrugated board box 10 and the number of sheets of the batch 50 of a new order when the order of sheet-shaped corrugated board boxes 10 is changed, but alternatively may be changed while the sheet-shaped corrugated board boxes 10 are being piled. Since the fall distance to the top surface of the batch 50 is large at the early stage of forming the batch 50 due to the small number of sheets being piled, the support ledges 25a and 25b are set at relatively high positions to reduce the fall distance. As the number of the sheets being piled increases, the fall distance to the top surface of the batch 50 decreases. For the above, the positions of the support ledges 25a and 25b may be lowered at a predetermined timing or gradually in accordance with the increasing number of the piled sheets.

Under the front stop 28, an elevator 32, which has a mount 322, is arranged. The mount 322 receives and supports the sheet-shaped corrugated board boxes 10 falling after hitting the front stop 28 and thereby forms the stack 50 by piling the sheets 10.

As shown in FIGS. 1-3, the elevator 32 includes a base 321 supported by a supporting axis 34, a first lift mechanism 33 that raises and lowers the base 321 in cooperation with the supporting axis 34, the mount 322 supported so as to ascend and descend with respect to the base 321, and a second lift mechanism 325 that raises and lowers the mount 322. The base 321 and the mount 322 are horizontally arranged across the point slightly ahead of and below the forwarding rolls 22 to the point under the front stop 28. The first lift mechanism 33 and the second lift mechanism 325 cooperatively serve as an elevator driving mechanism that raises and lowers the mount 322.

The first lift mechanism 33 includes a rack 33a arranged on the vertical supporting axis 34 along the axis direction of the axis 34, a pinion 33b that engages with the rack 33a, and a servomotor 35 coupled to the pinion 33b. The first lift mechanism 33 is configured to vertically drive the base 321.

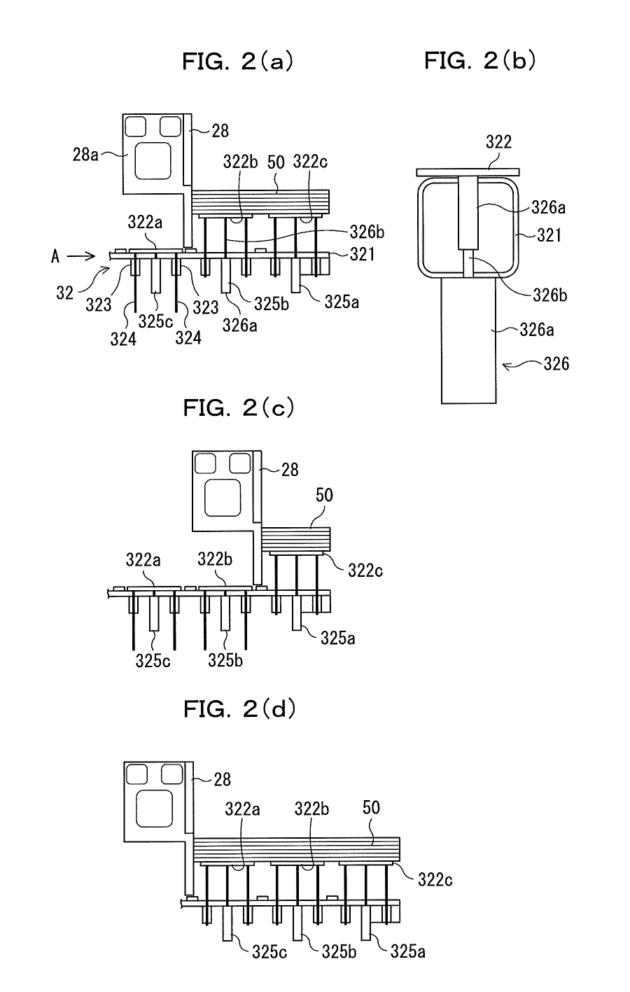

The second lift mechanism 325 includes an air cylinder 326a (see FIG. 2(b)) vertically fixed to the base 321, a piston rod 326b that upwardly moves in and out of the air cylinder 326a and having the upper end coupled to the mount 322, and a non-illustrated air pressure adjuster that adjusts the air pressure of a non-illustrated air chamber of the air cylinder 326a. The second lift mechanism 325 is configured to vertically move the mount 322 with respect to the base 321.

The first lift mechanism 33 and the second lift mechanism 325 are capable of simultaneously raising and lowering the base and the mount, so that the mount 322 of the elevator 32 is raised and lowered by two lift mechanisms of the first lift mechanism 33 and the second lift mechanism 325 that are arranged in series and are capable of simultaneously raising and lowering the mount 322. Alternatively, the base 322 of the elevator 32 may be raised and lowered by two or more lift mechanisms.

In the first embodiment, the mount 322 is formed of multiple segments arranged in the transfer direction of the sheet-shaped corrugated boards 10 (i.e., the direction from the forwarding rolls 22 to the front stop 28). The mount 322 of the first embodiment has three segments, in sequence from the upstream, a first mount segment 322a, a second mount segment 322b, and a third mount segment 322c. All the mount segments of the mount 322 are coupled to the piston rod 326b of the air cylinder 326a. Each mount segment 322h is raised and lowered with respect to the base 321 by a lift guide formed of multiple cylindrical guides 323 fixed to the base 321 and surrounding the air cylinder 326a and a axial guide 324 fixed to the mount 322 and sliding inside the cylindrical guide 323.

The mount 322 is divided into multiple segments in the transfer direction of the sheet-shaped corrugated board box 10 in order that, when the mount 322 is to be raised beyond the lower end of the front stop 28, the mount 322 does not interfere with the lower end of the front stop 28. Specifically, the front stop 28 horizontally moves in accordance with the length of the sheet-shaped corrugated board box 10 in the transfer direction, and one or more mount segments that do not interfere with the front stop 28 are used in accordance with the position of the front stop 28.

For example, if the sheet-shaped corrugated board box 10 has a middle length in the transfer direction as illustrated in FIG. 2(a), the third mount segment 322c located most downstream in the transfer direction is not used because the base segment 322c interferes with the front stop 28 when being raised, while the first mount segment 322a and the second mount segment 322b at the upper stream in the transfer direction are raised and used. If the sheet-shaped corrugated board box 10 has a small length in the transfer direction, as illustrated in FIG. 2(c), the third mount segment 322c and the second mount segment 322b located downstream in the transfer direction are not used because the base segments 322b and 322c interfere with the front stop 28 when being raised, while only the first mount segment 322a at the upper stream in the transfer direction is raised. If the sheet-shaped corrugated board box 10 has a large length in the transfer direction, as illustrated in FIG. 2(d), all the mount segments 322a-322c are raised because any mount segment does not interfere with the front stop 28 when being raised.

Such control of the elevator 32 is carried out by the controller 54. Specifically, the controller 54 determines one or more of the mount segments 322a-322c to be activated in accordance with the length of the sheet-shaped corrugated board box 10 in the transfer direction and sets the heights of the support ledges 25a and 25b in accordance with the thickness of the sheet-shaped corrugated board box 10 and the number of sheets included in the batch 50. After the setting, the controller 54 controls functioning of the first lift mechanism 33 and the second lift mechanism 325 that are to be activated so that the mount 322 receives the stack 50 from the support ledges 25a and 25b. Consequently, the mount 322 is moved to the height of the support ledges 25a and 25b.

Basically, the second lift mechanism 325 raises and lowers the mount 322 in addition to the raising and lowering of the mount 322 by the first lift mechanism 33. If the fall distance to the top surface of the stack is not large or if the heights of the support ledges 25a and 25b are set low for the sheet-shaped corrugated board boxes 10 being less likely to be unstably piled though the fall distance is large, the mount 322 can be raised and lowered only by the first lift mechanism 33.

In the first embodiment, the mount 322 is divided into the multiple mount segments 322a-322c arranged in the transfer direction of the sheet-shaped corrugated board box 10, and the controller 54 raises and lowers one or more of the mount segments 322a-322c that do not interfere with the front stop 28 in accordance with the position of the front stop 28.

Side frames 36 are disposed downstream of the hopper H on the both sides of the counter ejector 6 in the width direction, and each side frame 36 includes a horizontal rail 37. A ledge supporter 38 is supported on rails 37 on the both sides so as to travel along the rails 37. For this purpose, the ledge supporter 38 includes rollers 39 that travel on the respective rails 37, a non-illustrated pinion engaged with a non-illustrated rack arranged along either rail 37, and a servomotor 40 for forwarding/reversing ledge that rotates the pinion. Rotation of the servomotor 40 moves the ledge supporter 38 in the forward and backward directions.

A ledge 42 that horizontally extends is provided on the ledge supporter 38, being interposed by a lift mechanism 41. The lift mechanism 41 includes a non-illustrated rack and pinion mechanism, and a servomotor 43 for raising/lowering ledge that rotates the pinion. The rotation of the servomotor 43 raises and lowers the ledge supporter 38. The ledge 42 is disposed for the purpose of being activated when the number of the sheet-shaped corrugated board box 10 piled as the stack 50 reaches a predetermined number, to receive the sheet-shaped corrugated board boxes 10 to be piled as the next stack 50a. A press bar 44 that depresses the stack 50 is provided on a vertical member 42a of the ledge 42, being supported by a lift mechanism 45 so as to ascend and descend. The lift mechanism 45 includes a non-illustrated rack and pinion mechanism, and a servomotor 46 for raising/lowering press bar that rotates the pinion. Rotation of the servomotor 46 for raising/lowering press bar rises and lowers the press bar 44.

A lower conveyer 47 is disposed on the same level as the top surface of the elevator 32 at its possible lowest position, and an ejecting conveyer 48 is disposed downstream of the lower conveyer 47 on the same level as the lower conveyer 47. The lower conveyer 47 and the ejecting conveyer 48 are driven by a servomotor 47a and a servomotor 48a, respectively. The upstream end of the lower conveyer 47 is disposed inward of the elevator 32 so that the lower conveyer 47 is near enough to the pusher 27 to receive a sheet-shaped corrugated board box 10 minimum in length (minimum in length along the transfer direction).

An upper conveyor 49 that sandwiches the stack 50 in cooperation with the lower conveyer 47 and the ejecting conveyer 48 is disposed over the lower conveyer 47 and the ejecting conveyer 48 via a moving mechanism 49a, and the height of the upper conveyor 49 is adjustable. The upper conveyor 49 is also movable in the forward and backward directions by a moving mechanism 49b, and is configured to move in conjunction with the front stop 28 to a predetermined distance from the front stop 28 so as to fit the size of the sheet-shaped corrugated board box 10.

As one of the characteristic configurations of the counter ejector 6 of the first embodiment, fans (blowers) 56 that blow air AF onto the top surface of the sheet-shaped corrugated board box 10, which is forwarded from the forwarding rolls 22, are disposed over the elevator 32.

A photoelectric tube (detector means) 51 that detects the passage of a sheet-shaped corrugated board box 10 is disposed on the traveling path of the sheet in the counter ejector 6. The photoelectric tube 51 is electrically coupled to a controller (controller means, control device) 54 and transmits a passage signal P indicating detection of passage of a sheet to the controller 52.

Data M representing the operation speed v (i.e., the rotating speed of the forwarding roll 22 at that time) is transmitted to the controller 54 along with the passage signal P of the sheet-shaped corrugated board box 10, and the controller 54 calculates the time for the sheet-shaped corrugated board box 10 to reach the front stop 28 using the received data M and signal P, and transmits a signal (lowering signal) N that activates the ledge 42 to the servomotor 43 for raising/lowering ledge. For example, the controller 54 is configured to transmit a lowering signal N to the servomotor 43 for raising/lowering ledge after a time represented by ΔT=S/v has passed since the controller 54 received a passage signal P of the sheet-shaped corrugated board box 10, where a symbol S represents the distance between the photoelectric tube 51 and the front stop 28, and the symbol v represents the operation speed.

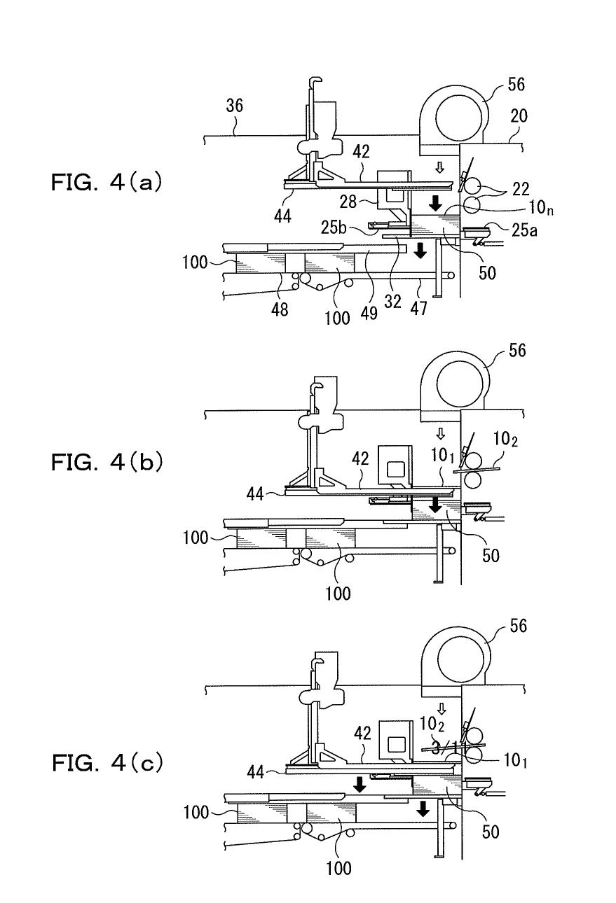

Next, description will now be made in relation to function of the counter ejector 6 with reference to FIGS. 4(a)-4(c), 5(a)-5(c), 6(a), and 6(b). FIGS. 4(a)-6(b) omit illustrations of the lift actuators 250A and 250B that respectively set the vertical positions of the support ledges 25a and 25b, which positions are assumed to be set beforehand by the controller 54 in accordance with the thickness of the sheet-shaped corrugated board box 10 and the number of sheets of the batch 50. The multiple lift mechanisms of the elevator 32 are also omitted in the drawings, but the operation of the elevator 32 is controlled by the controller 54 in accordance with the length of the sheet-shaped corrugated board box 10 along the transfer direction and the heights of the support ledges 25a and 25b. FIGS. 4(a)-6(b) use reference numbers 10₁, 10₂, and 10ₙ for discriminating the respective sheet-shaped corrugated board boxes 10.

FIG. 4(a) illustrates the counter ejector 6 immediately after the number of the sheet-shaped corrugated board boxes 10 piled as the stack 50 on the elevator 32 reaches the predetermined number. At the time the last sheet-shaped corrugated board box 10 to be piled as the stack 50 hits the front stop 28, the ledge 42 and the press bar 44 incorporated in the ledge 42 descend and, as illustrated in FIG. 4(b), receive a sheet-shaped corrugated board box 10₁ that is the first sheet to be piled as the next stack 50a. The instruction of the controller 54 to lower the ledge 42 is output based on a calculation of the time that takes for the last sheet-shaped corrugated board box 10ₙ (e.g. the 100-th sheet) at the photoelectric tube 51 to reach the front stop 28 using the passage signal P representing the reach of the front edge of the last sheet-shaped corrugated board box 10ₙ detected by the photoelectric tube 51 and the data M representing the operation speed at that time, and is transmitted to the lift mechanism 41.

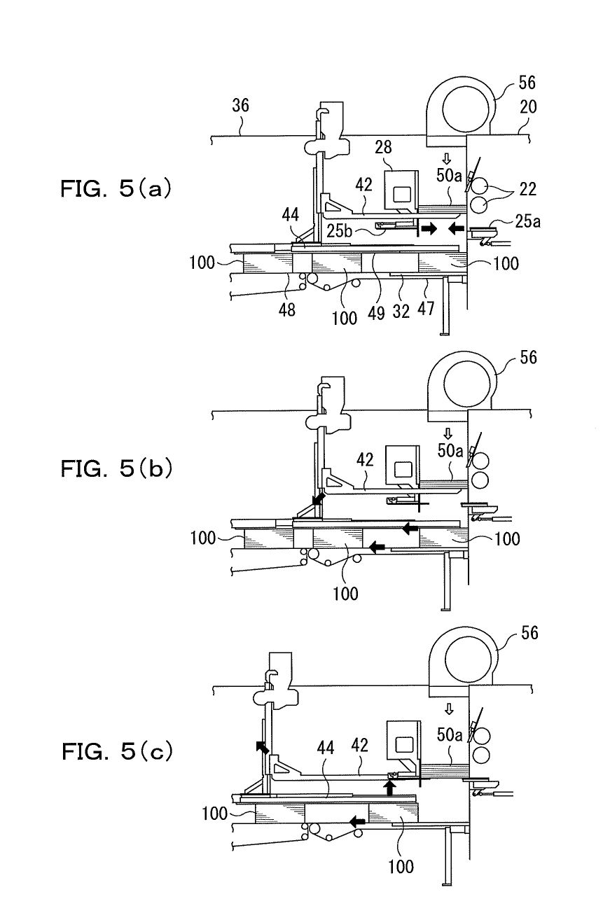

FIG. 4(c) illustrates the elevator 32 lowered to the same level as that of the lower conveyer 47. At the time depicted in FIG. 4(b), when the ledge 42 sequentially receives the sheet-shaped corrugated board boxes 10₁ and 10₂ that are to be piled as the next stack 50a, the elevator 32 immediately starts descending to the same level as that of the lower conveyer 47. In order to prevent the stack 50 from collapsing due to spring back, the press bar 44 is pressed down to a lower level than that of the ledge 42 and descends, sandwiching the stack 50 in cooperation with the elevator 32. Then when the top surface of the stack 50 passes the support ledges 25a and 25b, the support ledges 25a and 25b stick out to face each other as depicted in FIG. 5(a) and come into the stand-by state as depicted in FIG. 5(b). On the ledge 42, a next stack 50a is being formed.

In the state illustrated in FIG. 5(b), the pusher 27, which does not however appear in the drawing, pushes the stack 50 until the stack 50 is sandwiched by the upper conveyor 49. After that, the stack 50 pushed by the pusher 27 is brought out as a batch 100 by the lower conveyer 47, the ejecting conveyer 48 and the upper conveyor 49.

As illustrated in FIG. 5(c), when the batch 100 starts moving by the lower conveyer 47 and the ejecting conveyer 48, the press bar 44 slightly rises to leave the top surface of the batch 100. The ledge 42 evacuates together with the press bar 44 in such a position that the ledge 42 does not interfere with the stack 50a to wait for the next rise. At this time, the stack 50a on the ledge 42 is supported by the support ledges 25a and 25b and the sheet-shaped corrugated board box 10 falls on the top surface of the stack 50a on the support ledges 25a and 25b. During the above process, the batch 100 completely leaves the elevator 32.

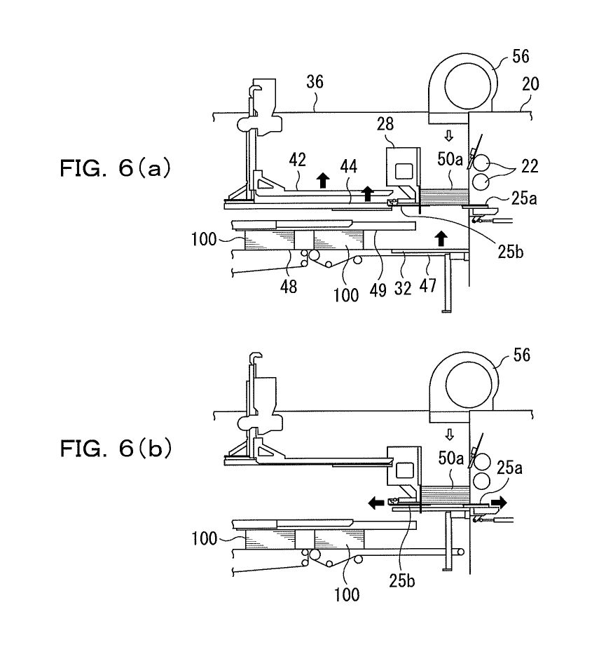

As illustrated in FIG. 6(a), when the batch 100 leaves the elevator 32, the elevator 32 rises until the top surface of the mount 322 that supports the stack 50a comes to be the same level as that of the top surface of the support ledges 25a and 25b. In succession, the support ledges 25a and 25b are retracted, and the stack 50a that has been on the support ledges 25a and 25b is taken over by the elevator 32. The elevator 32 receives the sheet-shaped corrugated board box 10 entering the hopper H at the same height as the support ledges 25a and 25b. At the same time, the press bar 44 is accommodated to the ledge 42 and, as illustrated in FIG. 6(b), the ledge 42 rises together with the press bar 44. When the ledge 42 reaches the same level as the state of FIG. 4(a), the ledge 42 moves forward to the position shown in FIG. 4(a). This cycle is repeated until a required number of batches 100 are brought out.

With the above configuration and function of the counter ejector 6 of the first embodiment, the positions of the support ledges 25a and 25b that receive the stack 50 on the ledge 42 are determined in accordance with the thickness of the sheet-shaped corrugated board box 10 and the number of sheets of the batch 50 such that the fall distance from a point where the sheet-shaped corrugated board box 10 enters the hopper H to the top surface of the stack piled in the hopper H is not excessively large. Consequently, the fall distance from a point where the sheet-shaped corrugated board box 10 enters the hopper H to the top surface of the stack piled in the hopper H can be suppressed. Thereby, the sheet-shaped corrugated board boxes 10 can be stably piled.

The mount 322 of the elevator 32 can be driven by the first lift mechanism 33 and the second lift mechanism 325, which are arranged in series and are capable of simultaneously raising and lowering the mount 322. Even when the support ledges 25a and 25b are set to be high to make the rise-and-lower stroke of the elevator long, the mount 322 can be rapidly raised and lowered by simultaneously activating the first lift mechanism 33 and the second lift mechanism 325.

Increasing the rise-and-lower stroke of the mount 322 of the elevator 32 does not always increase the cycle time of the raising and lowering of the elevator 32 and rather sometimes shortens the cycle time. Accordingly, it is possible to suppress the cycle time of the raising and lowering of the elevator 32, so that the cycle time can sufficiently catch up with the operation cycle time of the counter ejector.

Since the mount 322 is divided into multiple mount segments in the transfer direction of the sheet-shaped corrugated board box 10, the mount 322 even having a large length in the transfer direction of the sheet-shaped corrugated board box 10 can surely receive the sheet-shaped corrugated board box 10, not interfering with the lower end of the front stop 28, by raising and lowering the necessary area of the mount 322 in accordance with the length of the sheet-shaped corrugated board box 10 along the transfer direction when the mount 322 is raised higher than the lower end of the front stop 28.

Accordingly, the box former using the counter ejector 6 can always appropriately accomplish manufacturing of sheet-shaped corrugated board boxes 10 in accordance with various orders related to the thickness of the sheet-shaped corrugated board box 10 and the number of sheets of the batch 100, so that the versatility of the box former can be greatly improved.

### Second Embodiment

Next, description will now be made in relation to a counter ejector according to the second embodiment with reference to FIG. 8. Like reference numbers designate similar parts and element among FIG. 8 and the foregoing drawings, so detailed description is omitted here.

The counter ejector of the second embodiment is different only in the lift actuators for the support ledges 25a and 25b from that of the first embodiment.

As illustrated in FIG. 8, the lift actuator 252 that raises and lowers the support ledge 25a of the second embodiment includes a rack-and-pinion mechanism including a rack 252a fixed to the supporter 260 that supports the support ledge 25a and the air cylinder 26 and a pinion 252b that engages with the rack 252a, and a servomotor 253 that drives the pinion 252b. The rack 252a is arranged along the vertical direction. Rotating the pinion 252b by the servomotor 253 raises the supporter 260 together with the rack 252a and thereby, the support ledge 25a and the air cylinder 26 rise.

The lift actuator 254 that raises and lowers the support ledge 25b consists of a screw axis 254b screwed with a screw hole of a supporter 310 supporting the support ledge 25b and the air cylinder 31 and a servomotor 254a that drives the screw axis 254b. The screw axis 254b is arranged along the vertical direction. Rotating the screw axis 254b by the servomotor 254a raises and lowers the supporter 310 and thereby raises and lowers the support ledge 25b and the air cylinder 31.

Similarly to the first embodiment, this configuration allows the controller 54 to control the operation of the servomotors 253 and 254a. Specifically, the positions of the support ledges 25a and 25b that receive the stack 50 on the ledge 42 are set in accordance with the thickness of the sheet-shaped corrugated board box 10 and the number of sheets included in the batch 50 such that the fall distance from a point where the sheet-shaped corrugated board box 10 enters the hopper H to the top surface of the stack piled in the hopper H is not excessively large. Consequently, the fall distance can be suppressed. Thereby, the sheet-shaped corrugated board boxes 10 can be stably piled

### Third Embodiment

Next, description will now be made in relation to a counter ejector according to the third embodiment with reference to FIG. 9. Like reference numbers designate similar parts and element among FIG. 9 and the foregoing drawings, so detailed description is omitted here.

The counter ejector of the third embodiment is different only in the position setting mechanisms for the support ledges 25a and 25b from that of the first and second embodiments.

As illustrated in FIG. 9, the counter ejector of this embodiment includes multiple (two in this example) pairs of support ledges 25a and 25b disposed at vertically different positions and selects one pair of the support ledges 25a and 25b, so that vertical positions of the support ledges 25a and 25b are variably set.

Here, the counter ejector includes upper support ledges that consist of first support ledges 25a1 and 25b1 arranged at higher positions and first air cylinders 261 and 311 that horizontally drive the first support ledges 25a1 and 25b1, and lower support ledges that consist of second support ledges 25a2 and 25b2 arranged at lower positions and second air cylinders 262 and 312 that horizontally drive the second support ledges 25a2 and 25b2. The vertical positions of the air cylinders 261, 311, 262, and 312 are fixed.

The controller 54 selectively uses either the upper or the lower support ledges in accordance with the thickness of the sheet-shaped corrugated board box 10 and the number of sheets of the batch 50 such that the fall distance from the point where the sheet-shaped corrugated board box 10 enters the hopper to the top surface of the stack in the hopper H is not excessively large.

Substantially the same as the first and second embodiments, the controller 54 controls the operation of the servomotors 253 and 254a to set the positions of the support ledges 25a and 25b in accordance with the thickness of the sheet-shaped corrugated board box 10 and the number of sheets of the batch 50 such that the fall distance from the point where the sheet-shaped corrugated board box 10 enters the hopper H to the top surface of the stack in the hopper H is not excessively large. Thereby, the fall distance from the point where the sheet-shaped corrugated board box 10 enters the hopper H to the top surface of the stack in the hopper H can be suppressed and the sheet-shaped corrugated board boxes 10 can be stably piled.

### Fourth Embodiment

Next, description will now be made in relation to a counter ejector according to the fourth embodiment with reference to FIG. 10. Like reference numbers designate similar parts and element among FIG. 10 and the foregoing drawings, so detailed description is omitted here.

This embodiment is different from the first embodiment in the mechanism that drives an elevator 32B and also in the blower that blows air AF onto the surface of the sheet-shaped corrugated board box 10 forwarded from the forwarding rolls 22. The remaining configuration of this embodiment is the same as that of the first embodiment.

As illustrated in FIG. 10, a mount 321B of the elevator 32B is configured to take a single form corresponding to the base 321 of the first embodiment. The elevator driving mechanism that raises and lowers the mount 321B includes a first lift mechanism 33 and a second lift mechanism 328 that are simultaneously operable. The second lift mechanism 328 of the fourth embodiment is different from that of the first embodiment.

The first lift mechanism 33 includes a rack 33a arranged along the axis direction of a vertical supporting axis 34, a pinion 33b engaging with the rack 33a, and a servomotor 35 coupled to the pinion 33b. The first lift mechanism 33 is configured to move the supporting axis 34 upward and downward.

The second lift mechanism 328 includes a rack 328a arranged along the axis direction of the supporting axis 327 coupled to the mount 321B, a pinion 328b engaging with the rack 328a, and a servomotor 328c coupled to the pinion 328b fixed to a supporting axis 34. The second lift mechanism 328 is configured to move the supporting axis 327 upward and downward along the supporting axis 34.

Similarly to the first embodiment, the operation of the first lift mechanism 33 and the second lift mechanism 328 is controlled by the controller.

The counter ejector of the present embodiment further includes fans 52 and 53 that are disposed over the elevator 32 and that blow air AF to the top surface of the sheet-shaped corrugated board box 10 forwarded from the forwarding rolls 22. The fans 52 are fixed fans (fixed blowers) that are fixed to a beam 36a supported by the side frames 36 on the both sides, and the fans 53 are movable fans 53 (movable blowers) that are fixed to a beam 28a supported by the front stop 28 and move forward and backward together with the front stop 28.

Namely, as illustrated in FIG. 10, multiple (here, three) fixed fans 52 arranged in the width direction of the sheet-shaped corrugated board box 10 are fixed to the beam 36a supported by the both side frames 36 and multiple (here, two) movable fans 53 arranged in the width direction of the sheet-shaped corrugated board box 10 are fixed to the beam 28a supported by the front stop 28. Accordingly, the fixed fans 52 are arranged at positions corresponding to the rear-end portion of the hopper H in the transfer direction and the movable fans 53 are arranged at positions corresponding to the front-end portion of the hopper H in the transfer direction.

In this example, the fixed fans 52 are disposed near to the upper end of both side frames 36, at positions much higher than the level of the exit of the forwarding rolls 22 disposed while the movable fans 53 are disposed near to the upper end of front stop 28, at positions higher than but relatively closer to the level of the exit of the forwarding rolls 22.

With this configuration, since the large distance between the fixed fans 52 corresponding to the rear-end portion in the transfer direction and the sheet-shaped corrugated board box 10 lowers the speed of the blow but widens the area of the blow, the fixed fans 52 can blow air onto almost the entire surface of the sheet-shaped corrugated board box 10 without the aid of the movable fans 53 unless the sheet-shaped corrugated board box 10 is excessively large in size in the transfer direction. In contrast, the movable fans 53 corresponding to the front-end portion in the transfer direction, which are closer to the sheet-shaped corrugated board box 10, partially blow strong air to the front-end portion of the sheet-shaped corrugated board box 10, and can be efficiently used when sufficient air is not blown solely by the fixed fans 52.

Each of the fans 52 and 53 blows air along the downward vertical direction, that is, a direction perpendicular to near horizontal direction in which a sheet-shaped corrugated board box 10 is properly forwarded from the forwarding rolls 22. The fans 52 and 53 are surrounded by ducts 52a and 53a, which rectify the air blown by the respective fans 52 and 53 to the downward vertical direction.

Besides, the fans 52 and 53 are controlled independently of one another by the controller 54. Specifically, various data pieces such as the sizes (in both the transfer direction and the width direction), the material, the weight, and the flute of the sheet-shaped corrugated board box 10 are previously input into the controller 54, and the operation speed data of the box former is input into the controller 54. The controller 54 controls activation and halt of the respective fans 52 and 53 and an amount of air (amount of air per unit area, which is correlated with air speed and/or air pressure) during the activation using the above data pieces.

Specifically, a higher operation speed of the box former and a larger top-view area of the sheet-shaped corrugated board box 10 require faster fall of the sheet-shaped corrugated board box 10. For this purpose, the amount of air blown to the sheet-shaped corrugated board box 10 in the downward vertical direction (i.e., an amount of air blown to the entire sheet-shaped corrugated board box 10) needs to be large. However, when a strong blow (a large amount of blow per unit area, i.e., high air-speed blow) is locally applied to the sheet-shaped corrugated board box 10, the sheet-shaped corrugated board box 10 deforms and improperly behaves to fall in an improper posture.

Such deformation and behavior of the sheet-shaped corrugated board box 10 depend not only on the operation speed of the box former and the top-view area of the sheet-shaped corrugated board box 10 but also on the weight and the stiffness of the sheet-shaped corrugated board box 10. The weight and the stiffness of the sheet-shaped corrugated board box 10 are determined in terms of the material, the weight of the sheet-shaped corrugated board box 10, and a flute of the precursor corrugated board sheet. In this example, using these pieces of data, an optimum blowing area and an optimum amount of blow in each blowing area for the sheet-shaped corrugated board box 10 to be manufactured are acquired from test carried out in advance and are formed into a database. The controller 54 determines an optimum blowing area and an optimum amount of blow in each blowing area from the input data pieces with reference to the database and controls the fans 52 and 53 accordingly.

The above configuration of the counter ejector of this embodiment sets the positions of the support ledges 25a and 25b in accordance with the thickness of the sheet-shaped corrugated board box 10 and the number of sheets of the batch 50 such that the fall distance from the point where the sheet-shaped corrugated board box 10 enters the hopper H to the top surface of the pile in the hopper H is not excessively large. Thereby, it is possible to suppress the fall distance from the point where the sheet-shaped corrugated board box 10 enters the hopper H to the top surface of the pile in the hopper H, so that the sheet-shaped corrugated board boxes 10 can be stably piled.

The mount 321B of the elevator 32B is driven by the first lift mechanism 33 and the second lift mechanism 328 that are disposed in series and that can simultaneously raise and lower the mount 321B. With this configuration, even when the positions of the support ledges 25a and 25b are set to be high to make the rise-and-lower stroke of the elevator long, simultaneous operation of the first lift mechanism 33 and the second lift mechanism 328 can rapidly raise and lower the mount 321B of the elevator.

Further in this embodiment, the controller 54 adjusts the activation and halt (adjustment on the blowing area) of the respective fans 52 and 53 and the amount of air (amount of air per unit area, which is correlated with the air speed and/or air pressure) during the activation to the respective optimum states on the basis of the sizes (sizes in the transfer direction and the width direction), the material, the weight, and the flute of the sheet-shaped corrugated board box 10, and data of operation speed of the machine. Thereby, the sheet-shaped corrugated board box 10 can rapidly fall into the hopper H, keeping the proper posture and behavior and also the fast operation of the box former can be enhanced.

For example, if a sheet-shaped corrugated board box 10 has a large size in the transfer direction, the movable fans 53 disposed at the front-end portion in the transfer direction are activated to apply an air flow AF2 in addition to an air flow AF1 applied by the fixed fans 52 disposed at the rear-end portion in the transfer direction. This makes it possible to apply a sufficient air flow (AF1+AF2) to the entire sheet-shaped corrugated board box 10, preventing the air flow AF1 from the fixed fans 52 at the rear-end portion in the transfer direction from being excessively strong. Thereby, the sheet-shaped corrugated board box 10 can fall rapidly without causing improper posture and behavior of the sheet-shaped corrugated board box 10 due to an excessively strong air flow AF1.

Conversely, if the sheet-shaped corrugated board box 10 does not have the large size in the transfer direction, a strong air flow AF1 hardly causes improper posture and behavior of the sheet-shaped corrugated board box 10. For the above, the sheet-shaped corrugated board box 10 can fall rapidly and efficiently without causing the improper posture and behavior as the movable fans 53 at the front-end portion are brought to a halt and only the air flow AF1 from the fixed fans 52 at the rear-end portion is applied with strength conforming to the size of the sheet-shaped corrugated board box 10 and the operation speed of the box former.

The controller 54 controls the respective fans 52 and 53 based on the database so as to optimize the blowing area and the amount of air in each blowing area for the sheet-shaped corrugated board box 10 to be manufactured on the basis of the sizes (sizes in the transfer direction and the width direction), the material, the weight, and the flute of the sheet-shaped corrugated board box 10, and data of operation speed of the machine. Thereby, the sheet-shaped corrugated board box 10 can rapidly fall, even under various types of corrugated board sheets 10 or various operation conditions of the machine, avoiding improper posture and behavior of the sheet-shaped corrugated board box 10.

As an example of controlling the fans 52 and 53 of the first embodiment, an amount of air from the fixed fans 52 is set to be a constant value so as not to cause the sheet-shaped corrugated board box 10 to have improper posture and behavior and a lacking amount of air from the fans 52 is supplemented by air from the movable fans 53, so that the controlling can be accomplished by a simple logic. It is preferable that the supplemented amount of air from the movable fans 53 is controlled to be the lacking amount of air.

If the sheet-shaped corrugated board box 10 deforms (warps) in the width direction, adjusting the blowing area and an amount of air to be blown both in the width direction can inhibit the warp.

Normally, the sheet-shaped corrugated board box 10 is transferred with matching the direction (flute direction) in which the flute extends to the transfer direction. If a special sheet-shaped corrugated board box 10 may sometimes be transferred in the direction perpendicular to the flute direction, the sheet-shaped corrugated board box 10 tends to have a warp large in the transfer direction, so that more detailed setting of the blowing area and the amount of air is preferable. However, the above problem can be solved by, for example, increasing the numbers of fans 52 and 53.

### Others

Embodiments of the present invention are described as above, but the present invention should by no means be limited to the foregoing embodiments. Various modification, omission, and combination can be suggested without departing from the gist of the present invention.

Namely, the support ledges of the present invention satisfactorily include one or more position setting mechanisms that change the vertical positions of the support ledges, and the mechanism is not limited to those explained in the respective embodiments.

The configurations of the counter ejector and the box former of the foregoing embodiments are of course only examples, and can be changed and modified without departing from the spirit of the present invention.

### INDUSTRIAL APPLICABILITY

The present invention is applied to a box former that manufactures a sheet-shaped corrugated board, and in particular applied to a box former that properly manufactures sheet-shaped corrugated board boxes having various orders related to the thickness of the sheet and the number of sheets of each batch, so that the versatility of a box former can be greatly enhanced.

1. A counter ejector being disposed at a downstream part of a box former and including a hopper, the counter ejector receiving a sheet-shaped corrugated board box forwarded from an upstream side by the hopper and ejecting the sheet-shaped corrugated board box in units of batch, the counter ejector comprising:
a front stop that defines the hopper and stops the sheet-shaped corrugated board box forwarded from the upstream side;
an elevator that comprises a mount that receives the sheet-shaped corrugated board box falling after hitting the front stop;
a ledge that is activated when the number of sheet-shaped corrugated board box forming a stack piled on the mount reaches a predetermined number and that receives a sheet-shaped corrugated board box that is to form a next stack;
a support ledge that is disposed under the front of the hopper and that receives the stack formed on the ledge; and
a position setting mechanism that variably sets a vertical position of the support ledge.

2. The counter ejector according to claim 1, wherein the position setting mechanism comprises a lift actuator that raises and lowers the support ledge.

3. The counter ejector according to claim 2, further comprising control means that sets the optimum vertical position of the support ledge in accordance with the thickness of the sheet-shaped corrugated board box or the number of sheets included in the batch and that controls the lift actuator such that the support ledge comes to be at the optimum vertical position.

4. The counter ejector according to claim 1, wherein
the position setting mechanism comprises a plurality of the support ledges disposed at vertically different positions and sets the vertical position of the support ledge by selectively using one from the plurality of support ledges.

5. The counter ejector according to claim 4, further comprising control means that sets the optimum vertical position of the support ledge in accordance with the thickness of the sheet-shaped corrugated board box or the number of sheets included in a batch and that selectively activates one of the plurality of the support ledges that is at the closest to the optimum vertical position.

6. The counter ejector according to claim 1, further comprising:
a plurality of the support ledges disposed at the same height; and
a horizontal actuator that horizontally moves the plurality of support ledges such that the plurality of support ledges enter the hopper when the plurality of support ledges are activated to receive the stack on the ledge and evacuate from the hopper when the plurality of support ledges are not activated.

7. The counter ejector according to claim 6, wherein the plurality of the support ledges are disposed under the front stop and under a forwarding roll disposed at a downstream part of the box former.

8. The counter ejector according to claim 1, wherein:
the elevator comprises an elevator driving device that raises and lowers the mount; and
the elevator driving device comprises a plurality of lift mechanisms that are arranged in series and that are capable of simultaneously raising and lowering the mount.

9. The counter ejector according to claim 8, further comprising control means that causes the plurality of lift mechanisms to simultaneously raise and lower the mount when the mount of the elevator is raised and lowered.

10. The counter ejector according to claim 1, wherein the mount comprises a plurality of mount segments that are arranged in the transfer direction of the sheet-shaped corrugated board box and are configured to ascend and descend independently of one another.

11. The counter ejector according to claim 1, further comprising a blower that blows air from above the sheet-shaped corrugated board box to the hopper, wherein
the blower varies a blowing area at least along the transfer direction of the sheet-shaped corrugated board box, and
if the sheet-shaped corrugated board box has a possible maximum length in the transfer direction, the blower has the blowing area corresponding to at least the rear-end portion and the front-end portion of the hopper along the transfer direction.

12. A box former comprising:
a feed section that feeds a corrugated board sheet one at a time;
a print section that prints on the corrugated board sheet fed from the feed section;
a slotter creaser section that ejects the corrugated board sheet printed in the print section;
a die cutting section that die-cuts the corrugated board sheet ejected from the slotter creaser section;
a folder gluer section that glues and folds the edge of the corrugated board sheet processed by the die cutting section to thereby form a sheet-shaped corrugated board box; and
a counter ejector section that counts and piles the sheet-shaped corrugated board box processed by the folder gluer section, wherein
the counter ejector section comprising:
a front stop that defines a hopper and stops the sheet-shaped corrugated board box forwarded from an upstream side;
an elevator that comprises a mount that receives the sheet-shaped corrugated board box falling after hitting the front stop;
a ledge that is activated when the number of sheet-shaped corrugated board box forming a stack piled on the mount reaches a predetermined number and that receives a sheet-shaped corrugated board box that is to form a next stack;
a support ledge that is disposed under the front of the hopper and that receives the stack formed on the ledge; and
a position setting mechanism that variably sets a vertical position of the support ledge.

13. The counter ejector according to claim 3, further comprising:
a plurality of the support ledges disposed at the same height; and
a horizontal actuator that horizontally moves the plurality of support ledges such that the plurality of support ledges enter the hopper when the plurality of support ledges are activated to receive the stack on the ledge and evacuate from the hopper when the plurality of support ledges are not activated.

14. The counter ejector according to claim 4, further comprising:
a plurality of the support ledges disposed at the same height; and
a horizontal actuator that horizontally moves the plurality of support ledges such that the plurality of support ledges enter the hopper when the plurality of support ledges are activated to receive the stack on the ledge and evacuate from the hopper when the plurality of support ledges are not activated.

15. The counter ejector according to claim 5, further comprising:
a plurality of the support ledges disposed at the same height; and
a horizontal actuator that horizontally moves the plurality of support ledges such that the plurality of support ledges enter the hopper when the plurality of support ledges are activated to receive the stack on the ledge and evacuate from the hopper when the plurality of support ledges are not activated.

16. The counter ejector according to claim 3, wherein:
the elevator comprises an elevator driving device that raises and lowers the mount; and
the elevator driving device comprises a plurality of lift mechanisms that are arranged in series and that are capable of simultaneously raising and lowering the mount.

17. The counter ejector according to claim 4, wherein:
the elevator comprises an elevator driving device that raises and lowers the mount; and
the elevator driving device comprises a plurality of lift mechanisms that are arranged in series and that are capable of simultaneously raising and lowering the mount.

18. The counter ejector according to claim 16, further comprising control means that causes the plurality of lift mechanisms to simultaneously raise and lower the mount when the mount of the elevator is raised and lowered.

19. The counter ejector according to claim 17, further comprising control means that causes the plurality of lift mechanisms to simultaneously raise and lower the mount when the mount of the elevator is raised and lowered.

20. The counter ejector according to claim 3, further comprising:
a plurality of the support ledges disposed at the same height;
a horizontal actuator that horizontally moves the plurality of support ledges such that the plurality of support ledges enter the hopper when the plurality of support ledges are activated to receive the stack on the ledge and evacuate from the hopper when the plurality of support ledges are not activated;
control means that causes the plurality of lift mechanisms to simultaneously raise and lower the mount when the mount of the elevator is raised and lowered; and
a blower that blows air from above the sheet-shaped corrugated board box to the hopper, wherein:
the plurality of the support ledges are disposed under the front stop and under a forwarding roll disposed at a downstream part of the box former;
the elevator comprises an elevator driving device that raises and lowers the mount;
the elevator driving device comprises a plurality of lift mechanisms that are arranged in series and that are capable of simultaneously raising and lowering the mount;
the mount comprises a plurality of mount segments that are arranged in the transfer direction of the sheet-shaped corrugated board box and are configured to ascend and descend independently of one another;
the blower varies a blowing area at least along the transfer direction of the sheet-shaped corrugated board box; and
if the sheet-shaped corrugated board box has a possible maximum length in the transfer direction, the blower has the blowing area corresponding to at least the rear-end portion and the front-end portion of the hopper along the transfer direction.
